(19) United States
(12) Patent Application Publication
(10) Pub. No.: US 2010/0265871 A1
(43) Pub. Date: Oct. 21, 2010

(54) BEACON RE-BROADCASTING APPARATUS, BEACON RE-BROADCASTING METHOD, AND INITIAL ACCESS REQUEST METHOD IN WIRELESS NETWORK

(75) Inventors: Gwangzeen Ko, Seoul (KR); Myung-Sun Song, Daejeon-City (KR); Sung-Hyun Hwang, Daejeon-City (KR); Jung-Sun Um, Suwon-city, Gyeonggi-do (KR); Chang-Joo Kim, Daejeon-City (KR); Sung-Jin You, Daejeon-City (KR)

Correspondence Address: LAHIVE & COCKFIELD, LLP;FLOOR 30, SUITE 3000, ONE POST OFFICE SQUARE, BOSTON, MA, 02109, US

(73) Assignee: ELECTRONICS AND TELECOMMUNICATIONS RESEARCH INSTITUTE, DAEJEON-CITY (KR)

(21) Appl. No.: 12/746,718

(22) PCT Filed: Nov. 19, 2008
(86) PCT No.: PCT/KR08/06805

§ 371 Date: Jun. 7, 2010

(30) Foreign Application Priority Data
Dec. 7, 2007 (KR) 10-2007-0126877

(51) Int. Cl. H04W 72/04; H04B 7/14

(52) U.S. Cl. 370/315; 370/336

(57) ABSTRACT

Provided are a beacon re-broadcasting apparatus, a beacon re-broadcasting method, and an initial access request method in a wireless network. In the re-broadcasting apparatus and method, a beacon frame including beacon information for communications in the wireless network and information on an echo beacon slot allocated for beacon re-broadcasting among time slots of a superframe is received from a management device for managing the wireless network in which a plurality of terminals communicated with each other through the superframe including time-divided time slots, and the beacon information is re-broadcasted during the echo beacon slot. Accordingly, the beacon information can be received in various environments, and the beacon information can be received to an adjacent network in addition to the corresponding network. Therefore, frequency resources can be shared and effectively used between networks, and convenience and efficiency in network operation can be maximized.

### TECHNICAL FIELD

The present invention relates to a beacon re-broadcasting apparatus, a beacon re-broadcasting method, and an initial access request method using an echo beacon protocol (EBP) in a wireless network, and more particularly, to a beacon re-broadcasting apparatus, a beacon re-broadcasting method, and an initial access request method, capable of sharing and effectively using frequency resources between networks through beacon re-broadcasting and maximizing convenience and efficiency in network operation.

The present invention is derived from a research project supported by the Information Technology (IT) Research & Development (R&D) program of the Ministry of Information and Communication (MIC) and the Institute for Information Technology Advancement (IITA) [2005-S-002-03, Development of Cognitive Radio Technology for Efficient Spectrum Utilization].

### BACKGROUND ART

Conventional wireless personal area networks (WPANs) such as in IEEE 802.15.1.3, and 4 use operation frequencies of corresponding systems, which are allocated by governments of particular countries in advance, so that finding and managing frequencies to be operated by the WPANs are not important.

However, in a state where a system that is not allocated with a specific frequency band from the government but is granted with using a frequency at a predetermined band (for example, TV band) from the government operates in advance, in a PAN based on a cognitive radio technology in which an incumbent user (IU) continuously scans corresponding frequencies to find and use a frequency that is not used by the IU at a particular time period, unlike in the existing PAN, strict power control is required so that an operation frequency is set at an initial structure of a network and the IU is not interfered.

### DISCLOSURE OF INVENTION

### Technical Problem

The aforementioned limitations in the PAN based on a cognitive radio technology, result in strict limitations on a range of beacon signals for determining a coverage of the network, and the beacon signal cannot be received in a particular region. Accordingly, many problems such as the need of exchanges of cognitive radio information such as frequency usage information between networks, a problem of acquiring a network beacon outside a transmission range in a power controlled state, a problem of setting an initial transmission power, and a problem about a device that exists in an overlap area between a plurality of networks and cannot properly receive beacons, occur.

### Technical Solution

The present invention provides a beacon re-broadcasting apparatus, a beacon re-broadcasting method, and an initial access request method, capable of sharing and effectively using frequency resources between networks by using an echo beacon protocol (EBP) in a wireless network and maximizing convenience and efficiency in network operation.

### ADVANTAGEOUS EFFECTS

Accordingly, many problems that occur due to beacon power transmission control in a PAN such as the need of exchanges of cognitive radio information such as frequency usage information between networks, a problem of acquiring a network beacon outside a transmission range in a power controlled state, a problem of setting an initial transmission power, and a problem about a device that exists in an overlap area between a plurality of networks and cannot properly receive beacons, can be solved. Therefore, the beacons can be received in various environments and beacons in an adjacent external network in addition to a corresponding network can be received. In addition, frequency resources between the networks can be shared and effectively used, and convenience and efficiency in network operation can be maximized.

### DESCRIPTION OF DRAWINGS

The above and other features and advantages of the present invention will become more apparent by describing in detail exemplary embodiments thereof with reference to the attached drawings in which:

FIGS. 1A to 1D are views illustrating situations in which problems in that a terminal does not receive a beacon in a wireless network based on a cognitive radio technology;

FIG. 2 is a view illustrating a structure of a beacon re-broadcasting apparatus in a wireless network according to an embodiment of the present invention;

FIG. 3 is a flowchart of a beacon re-broadcasting method used in the wireless network according to the embodiment of the present invention;

FIG. 4 is a view illustrating a structure of a superframe used in the wireless network according to the embodiment of the present invention;

FIG. 5 is a flowchart of an initial access request method used in the wireless network according to the embodiment of the present invention;

FIG. 6 is a view illustrating operations of solving the initial access problem according to the embodiment of the present invention;

FIG. 7 is a flowchart of an initial access request method used in a wireless network according to another embodiment of the present invention;

FIG. 8 is a view illustrating operations of solving the overlap area problem according to another embodiment of the present invention; and

FIG. 9 is a view illustrating operations of solving an initial interference problem according to another embodiment of the present invention.

### BEST MODE

According to an aspect of the present invention, there is provided a beacon re-broadcasting apparatus in a wireless network in which a plurality of terminals communicate with each other through a superframe including time-divided time slots, including: a beacon frame receiver receiving, from a management device managing the wireless network, a beacon frame including beacon information for communications in the wireless network and information on an echo beacon slot allocated for beacon re-broadcasting among the time slots of the superframe; and a beacon re-broadcaster rebroadcasting the beacon information during the echo beacon slot.

According to another aspect of the present invention, there is provided a beacon re-broadcasting method in a wireless network in which a plurality of terminals communicate with each other through a superframe including time-divided time slots, including: a beacon frame reception operation of receiving, from a management device managing the wireless network, a beacon frame including beacon information for communications in the wireless network and information on an echo beacon slot allocated for beacon re-broadcasting among the time slots of the superframe; and a beacon re-broadcasting operation of rebroadcasting the beacon information during the echo beacon slot.

According to another aspect of the present invention, there is provided an initial access request method used in a wireless network in which a plurality of terminals communicate with each other through superframes including time-divided time slots, including: receiving beacon information including information on a CAP slot for initial access to the wireless network among the time slots of the superframe from a terminal in the wireless network; and transmitting an initial access request message for re-questing initial access to the wireless network during the CAP slot.

According to another aspect of the present invention, there is provided an initial access request method used in a wireless network in which a plurality of terminals communicate with each other through a superframe including time-divided time slots, including: receiving first beacon information including information on a CAP slot for initial access to a first wireless network among the time slots of the superframe in the first wireless network from a terminal that belongs to the first wireless network; receiving second beacon information on a frequency channel used in a second wireless network and information on each of the time-divided time slots from one or more of a management device in the second wireless network and terminals that belong to the second wireless network; and transmitting an initial access request message for re-questing initial access to the first wireless network during the CAP slot of the first wireless network that is determined not to affect the second wireless network on the basis of the second beacon information.

### MODE FOR INVENTION

The principle of the present invention is exemplified. Therefore, those skilled in the art can invent various apparatuses that implement the principle of the present invention and are included in the concept and range of the present invention although the apparatuses are not described in detail and illustrated in the specification. In addition, it should be noted that all conditional terms and embodiments provided in the specification are intended only for purpose of providing a sufficient understanding of the present invention and are not limited to embodiments and states provided in the specification. In addition, all the descriptions providing particular embodiments in addition to the principles, aspects, and embodiments of the present invention are intended to include structural and functional equivalents. In addition, the equivalents include equivalents that will be developed, that is, any device invented to perform the same function regardless of a structure, in addition to published equivalents.

Therefore, functions of various units illustrated in the drawings such as processors or function blocks displayed to have similar concepts may be used for dedicated hardware and hardware capable of executing associated software. When the functions are provided by the processors, the functions may be provided by a single dedicated processor, a single shared processor, or a plurality of individual processors, and parts of those may be shared. In addition, the use of terms such as processors, controls, or terms introduced to have similar concepts may not be construed to exclude hardware capable of executing associated software; rather, the use thereof implicitly includes the use of digital signal processors (DSP) hardware, read-only memory (ROM), random-access memory (RAM), and a non-volatile memory for storing the software. Other hardware in old combinations may be included.

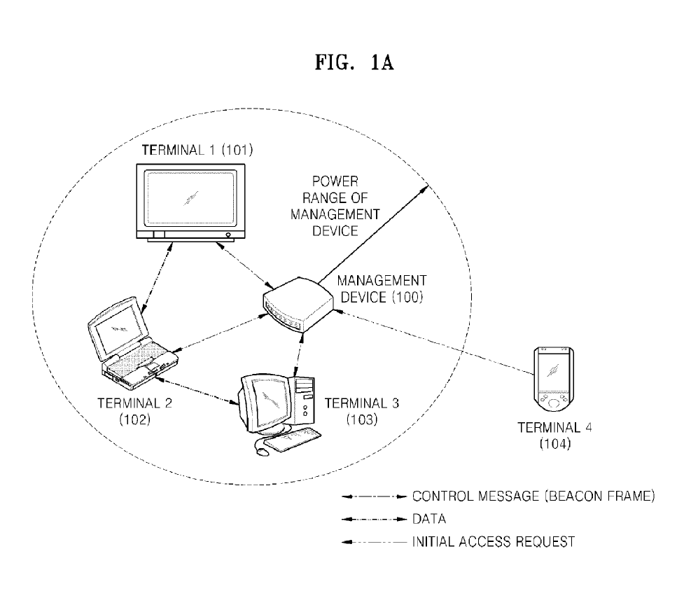

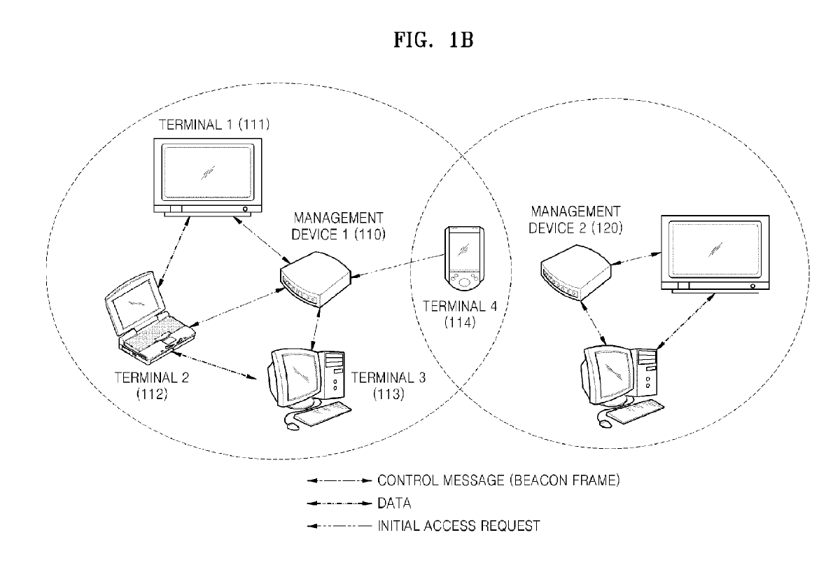

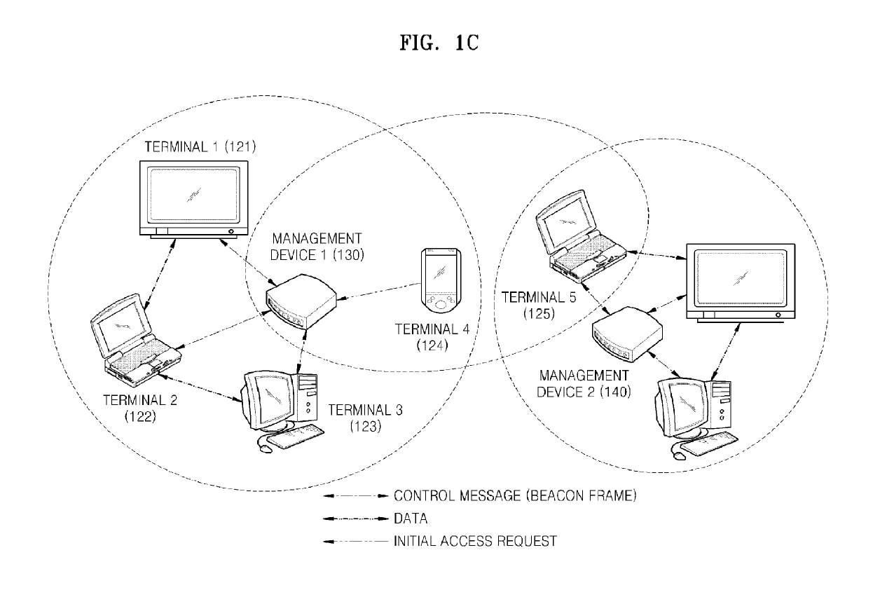

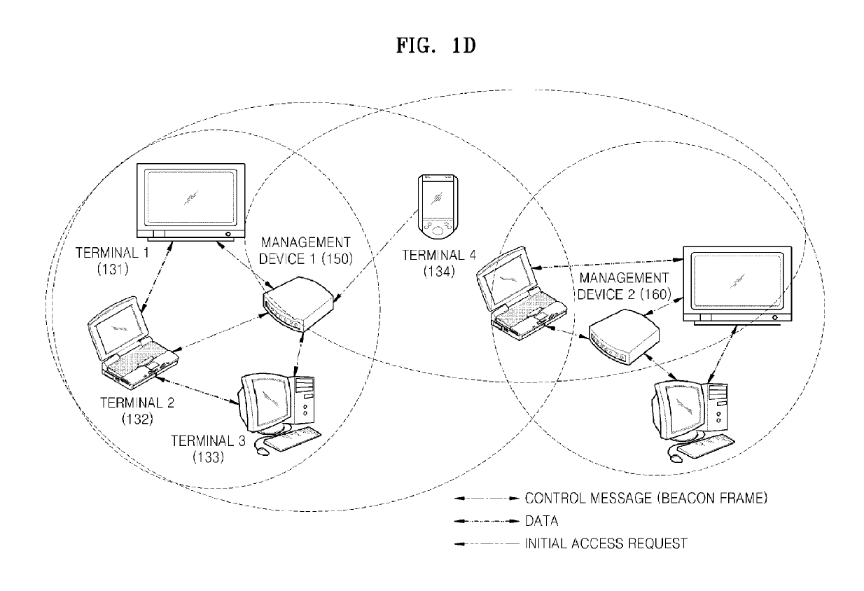

Exemplary embodiments of the present invention will now be described in detail with reference to the accompanying drawings. In the description, the detailed descriptions of well-known functions and structures may be omitted so as not to hinder the understanding of the present invention. Like reference numerals designate like elements throughout the specification.
1. FIGS. 1A to 1D are views illustrating situations in which problems in that a terminal does not receive a beacon and cannot request an initial access or a terminal generates an interference in an adjacent network, in a wireless network based on a cognitive radio technology.
1. Since an existing communication system uses permitted frequencies, a management device for controlling and managing a network transmits a beacon frame in an allocated frequency range, and terminals (devices) that cannot receive the beacon frame are not provided with services or the terminal generates a new network by functioning as a management device for the new network.

However, a wireless personal area network (WPAN) based on a cognitive radio technology has limitations to transmit a beacon frame.

First, there is uncertainty of a frequency band for transmitting the beacon frame. This is because an incumbent user (IU) searches for a particular frequency that is not used to set a new network in the searched frequency. In this case, it is more difficult for terminals that are to be connected to the set network to search for the frequency in which the network is set as compared with a conventional system.

Second, in order for the management device to transmit the beacon frame, due to characteristics of the cognitive radio system that implicitly assumes that an IU operates around a network, the management device has to be designed to reduce an interference in the IU as much as possible. Therefore, in order to reduce the interference, power to transmit the beacon frame is controlled, and at this time, the transmission power has to be controlled so that only terminals connected to the network are properly provided with services. This causes a decrease in a network coverage, so that hidden nodes that cannot receive the beacon frame transmitted by the management device exist in a larger area.

Last, if there is no effective information exchange between adjacent networks for frequency usages, the networks use the same frequency. In this case, a new terminal in the overlap area receives signals in the two networks simultaneously, so that the terminal in a corresponding network region cannot properly receive the beacon frame.

Referring to FIG. 1A, a management device 100 transmits a beacon frame in a state where power is controlled so that terminals 1 to 3 101 to 103 have a minimum power range to receive the beacon frame. Here, a terminal 4 104 that is outside the minimum power range but wants to access to the wireless network cannot receive the beacon frame transmitted from the management device. Therefore, an initial access problem in which the terminal 4 cannot request an initial access of the management device occurs.

Referring to FIG. 1B, when adjacent two networks use the same frequency, a terminal 4 114 in an overlap area between the two networks may simultaneously receive the beacon frames transmitted from management devices 110 and 120 in the two networks and cannot properly receive the beacon frames. Particularly, when a signal of an adjacent network is periodically transmitted at time points at which the beacon frame of the network that is to access to is transmitted and a collision occurs, an overlap area problem in that the beacon frame of the network that is to access to cannot be received before a transmission period of one of the two networks is changed, occurs.

Referring to FIG. 1C, when a terminal 4 124 does not recognize an existence of a terminal 5 125 and requests an initial access of a management device 1 130 through a time slot that generates a collision with a transmission period of a signal of the adjacent network, an initial interference problems in that an interference in the adjacent network is generated occurs.

Each of the problems in the aforementioned three cases affects the networks. In addition, as illustrated in FIG. 1D, the problems may simultaneously occur, and in this case, it results in more complex problems.

Referring to FIG. 1D, a terminal 4 134 that is outside a transmission range of a management device 1 150 cannot receive a beacon frame from the management device 1 150, and an initial access problem in that the terminal 4 134 cannot request an initial access of the management device 1 150. In addition, the terminal 4 134 does not know beacon information on an adjacent network, so that the terminal 4 134 may generate the initial interference problem in that the terminal 4 134 generates the interference in the adjacent network.

A management device 2 160 generates an interference on the management device 1, so that the management device 2 160 may raise a serious problem to a network of the management device 1.
1. This shows that the two problems illustrated in FIGS. 1A and 1C may simultaneously occur.

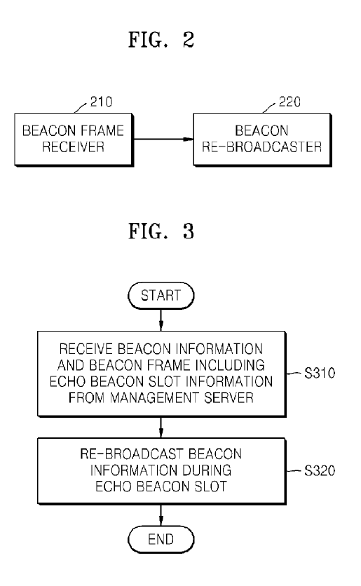

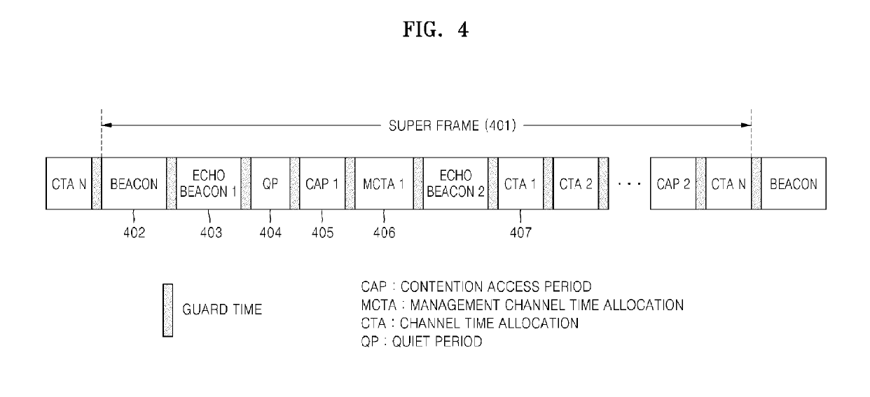

FIG. 2 is a view illustrating a structure of a beacon re-broadcasting apparatus in a wireless network according to an embodiment of the present invention. FIG. 3 is a flowchart of a beacon re-broadcasting method performed by the beacon re-broadcasting apparatus in the wireless network illustrated in FIG. 2.

Referring to FIG. 2, the beacon re-broadcasting apparatus in the wireless network according to the current embodiment includes a beacon frame receiver 210 and a beacon re-broadcaster 220.

The beacon frame receiver 210 receives, from a management device for managing a wireless network in which a plurality of terminals communicate with each other through superframes including time-divided time slots, a beacon frame including beacon information for communication in the wireless network and information on an echo beacon slot allocated for beacon re-broadcasting in the time slots of the superframe in operation S310.

The wireless network according to the current embodiment indicates a network in which a management device (or coordinator) performs transmission power control, such as a PAN based on the cognitive radio technology. Therefore, although not based on the cognitive radio technology, a system in which a network coordinator such as an access point (AP) in IEEE 802.11 or a piconet coordinator (PNC) in IEEE 802.15 performs the transmission power control may apply the current embodiment.

Here, the beacon information includes information on a location and a length on the superframe, a modulation scheme, a coding scheme, and an allocated terminal for each of the time-divided time slots. Moreover, the beacon information may further include information on a backup channel that can be used when a problem of a frequency channel used for a wireless network to perform a cognitive radio function or a frequency channel that is being used occurs, and information on a quiet period (QP) used to search for an appearance of an IU in the frequency channel that is being used.

FIG. 4 is a view illustrating a structure of the superframe used in the wireless network according to the embodiment of the present invention.

Referring to FIG. 4, the superframe 401 includes time slots such as a channel time allocation (CTA) slot 407, a management channel time allocation (MCTA) slot 406, a contention access period (CAP) slot 405, a QP slot 404 for searching for a signal of an IU in a cognitive radio technology, a beacon slot 402, an echo beacon slot (EBP) slot 403, and the like.

The CTA slot is a slot for communications between a plurality of terminals, the MCAT slot is a slot for transmission/reception of control information between a management device and the terminals, and the CAP slot is a slot for transmission and initial access of data with a small length.

In addition, the QP slot is a slot for searching for the signal of the IU without its interference in its operation frequency in order to support the cognitive ratio function.

In addition, the beacon slot is a slot for transmitting a beacon frame from the management device to each terminal.

In addition, the EBP slot is a slot for beacon re-broadcasting from the terminals according to the current embodiment. The EBP slot operates in two modes. There are a relay mode and a coexistence mode. The EBP slot in the relay mode (hereinafter, referred to as a relay mode beacon slot) is a slot for re-broadcasting to an adjacent terminal in the same wireless network, and the EBP slot in the coexistence mode (hereinafter, referred to as a coexistence mode beacon slot) is a slot for re-broadcasting to an adjacent external terminal that does not belong to the wireless network to which the terminal belongs.

In the structure of the superframe according to the current embodiment, the EBP slots are allocated to a plurality of time slots separated from each other. Specifically, the EBP slots are separated from each other in the time domain so that the adjacent terminal in the same wireless network or the adjacent external terminal can keep away from an interference source operating in an adjacent network or in a specific time period and receive the beacon. In addition, the CAP slots for transmitting a signal to the management device by a terminal are allocated to a plurality of time slots separated from each other so that the CAP slots can avoid affects from the adjacent network and can be selected in the time domain.

The beacon re-broadcaster 220 extracts information on the echo beacon slot from the beacon frame received by the beacon frame receiver 210 and re-broadcasts beacon information during the extracted echo beacon slot in operation S320. In the description, in order to distinguish the beacon information re-broadcasted by the terminal during the echo beacon slot from the beacon frame transmitted by the management device, the re-broadcasted echo beacon is called an echo beacon.

In this case, when the entire beacon frame is re-broadcasted, redundant information may be re-broadcasted, and this causes an unnecessary overhead. Therefore, in order to reduce the overhead, parts of the information included in the beacon frame are re-broadcasted. The parts to be re-broadcasted in the relay and coexistence modes are different from each other.

The beacon re-broadcaster 220 transmits information on a location and a length on the superframe, a modulation scheme, a coding scheme, an allocated terminal, an the like for each of the time-divided time slots among the beacon information to an adjacent terminal in the wireless network, during the relay mode beacon slot of the echo beacon slots.

Specifically, in the relay mode, in order to expand a beacon coverage in the same network by transmitting the beacon information to terminals in a shadow region that cannot receive the beacon frame transmitted by the management device in the same network, a period, a length, a modulation scheme and a coding scheme of a beacon among the beacon information stored in the beacon frame, a location and a length of a CAP slot among the time slots in the superframe, a location and a length of an MCTA slot among the time slots in the superframe, a location, a length, a modulation scheme and a coding scheme of the CTA slot among the time slots in the superframe, an identification (ID) of a terminal using the CTA slot, and QP information needed for cognitive wireless communication, and the like are re-broadcasted. As described above, the beacon information (hereinafter, referred to as the relay mode beacon information) re-broadcasted in the relay mode is generated by deciphering the beacon and data in the terminal in the same network and re-combining variables for maintaining operations of the network.

The beacon re-broadcaster 220 transmits information on a frequency channel used in the wireless network, a location and a length on the superframe, and the like for each of the time-divided time slots among the beacon information to an external terminal that is not in the same wireless network, during the coexistence mode beacon slot of the echo beacon slots.

In the coexistence mode, the beacon information is transmitted to an adjacent external network to reduce an interference between the adjacent networks in the time domain. In addition, in order to remove redundancy in the frequency domain, among the beacon information stored in the beacon frame, a plurality of a frequency channel using a corresponding network, a period of the beacon, a location of the CAP slot, a location of the MCTA slot, a location and a length of the CTA slot, an ID of a terminal using the CTA slot, a list of backup channels, the QP information, and the like are re-broadcasted.

As described above, the beacon information re-broadcasted in the co-existence mode (hereinafter, referred to as the coexistence mode beacon information) is generated by re-combining location information in the time domain in the entire superframe and information needed to perceive a frequency status and a traffic status of the corresponding network.

As described above, due to the re-broadcasting of the beacon information through the echo beacon slots, a time to transmit data can be reduced. This may result in a slight decrease in an efficiency of the network. However, the EBP slot are not allocated to each superframe but periodically allocated to a plurality of superframes, so that the entire efficiency is not significantly decreased.

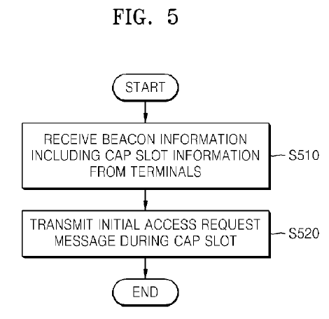

FIG. 5 is a flowchart of an initial access request method used in the wireless network according to the embodiment of the present invention.

First, the beacon information including information on the CAP slot for initial access to the wireless network among the time slots in the superframe is received from a terminal belongs to the wireless network in operation S510. Specifically, among the time slots in the superframe, through the echo beacon slot allocated for beacon re-broadcasting, the beacon information, that is, the echo beacon is received.

During the CAP slot extracted from the beacon information received in operation S510, the initial access request message for requesting an initial access to the wireless network is transmitted in operation S520. The initial access request message may include a media access control (MAC) address of a terminal that is to request the initial access and an amount of data to be transmitted.

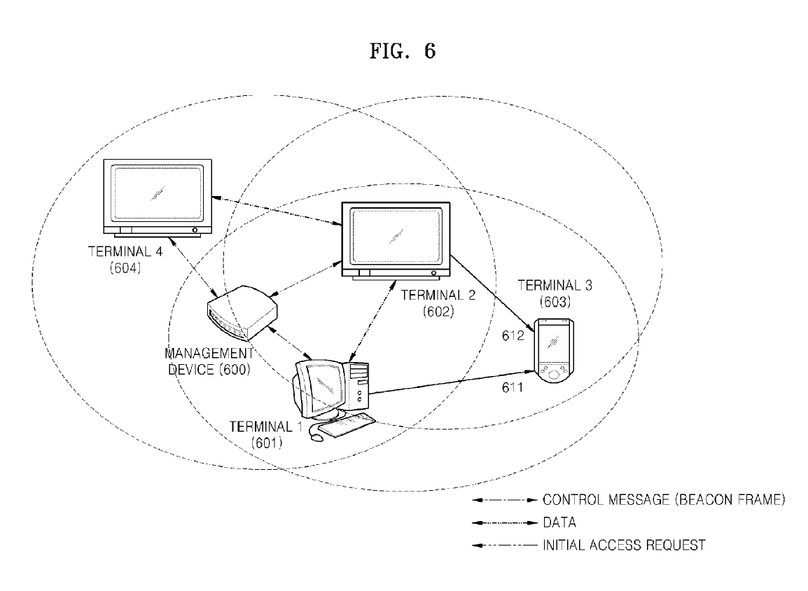

FIG. 6 is a view illustrating a state where a terminal that is outside a transmission range of a management device solves the initial access problem illustrated in FIG. 1 by using the initial access request method illustrated in FIG. 5.

Referring to FIG. 6, a terminal 1 601 and a terminal 2 602 re-broadcast (in the relay mode) beacon information through corresponding EBP slots in the superframe in operations 611 and 612.

A terminal 3 603 is outside a transmission range and cannot receive the beacon frame transmitted from the management device. However, the terminal 3 603 receives the beacon information re-broadcasted from the terminal 1 601 and the terminal 2 602, that is, the echo beacon through different EBP slots twice (operations 611 and 612) and so receive the beacon information outside the transmission range of the management device. Therefore, the terminal 3 603 can extract the CAP slot for initial access from the beacon information and request the initial access through the CAP slot. Therefore, the initial access problem illustrated in FIG. 1 can be solved.

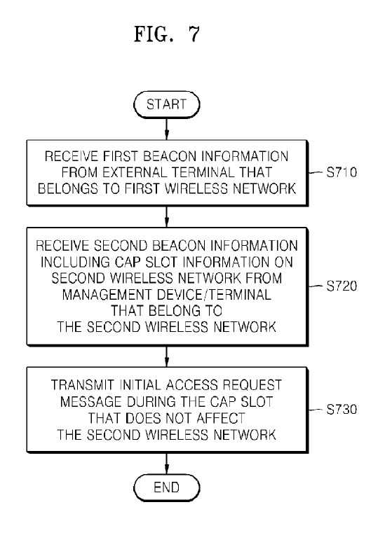

FIG. 7 is a flowchart of an initial access request method used in a wireless network according to another embodiment of the present invention.

First beacon information including information on a CAP slot for initial access to a first wireless network among time slots of a superframe in the first wireless network is received from a terminal that belongs to the first wireless network in operation S710. Specifically, through an echo beacon slot allocated for beacon re-broadcasting among the time slots of the superframe in the first wireless network, the first beacon information (referred to as an echo beacon) is received. The CAP for initial access to the first wireless network can be perceived on the basis of the received first beacon information.

Second beacon information including information on a frequency channel used in a second wireless network and each of time-divided time slots is received from a management device in a second wireless network and one or more terminals that belong to the second wireless network in operation S720. Specifically, a beacon frame transmitted from the management device in the second wireless network and the echo beacon re-broadcasted from the terminals that belong to the second wireless network are received. On the basis of the received second beacon information, time-divided time slots in the second wireless network can be perceived.

By comparing the CAP slot for initial access to the first wireless network perceived in operation S710 with the time slot in the second wireless network perceived in operation S720, the CAP slot in the first wireless network that does not affect the second wireless network is selected to transmit an initial access message to the first wireless network in operation S730. For example, when there are a plurality of CAP slots in the first superframe, only a slot that does not overlap with the time slot of the superframe in the second wireless network is selected from the number of CAP slots.

When a CAP slot in the first wireless network that does not affect the second wireless network is not found, a next beacon frame or echo beacon is received to attempt initial access through a CAP slot of a next superframe.

In operation S730, the initial access request message for requesting initial access to the second wireless network is transmitted during the CAP slot extracted from the second beacon information received in operation S720 When there are a plurality of CAP slots in the superframe, a slot that does not overlap with a time slot of the superframe in the second wireless network from the number of CAP slots to transmit the initial access request message.

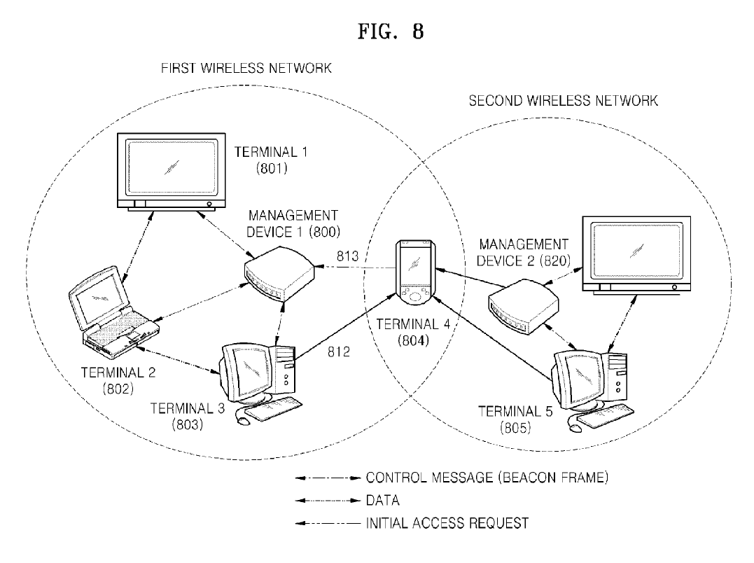

FIG. 8 is a view illustrating a state where a terminal that is in an overlap area between two networks solves the overlap area problem illustrated in FIG. 1B by using the initial access request method.

Referring to FIG. 8, a terminal 3 803 and a terminal 5 805 re-broadcast beacon information in operations 811 and 812.

A terminal 4 804 receives beacon frames transmitted from a management device 1 800 and a management device 2 820 or beacons that do not generate a collision in the time domain from beacon information re-broadcasted from the terminal 3 803 and the terminal 5 805 to receive information on two networks. Thereafter, in operation 813, the terminal 4 804 can request initial access to a first wireless network through a CAP slot in the first wireless network but does not affect a second network to which the management device 2 belongs. Therefore, the overlap area problem illustrated in FIG. 1B can be solved. Although all beacons generate collisions in the time domain, since EBP slots are allocated to different locations of superframes, the continued state in which all of the beacons generate collisions can be avoided.

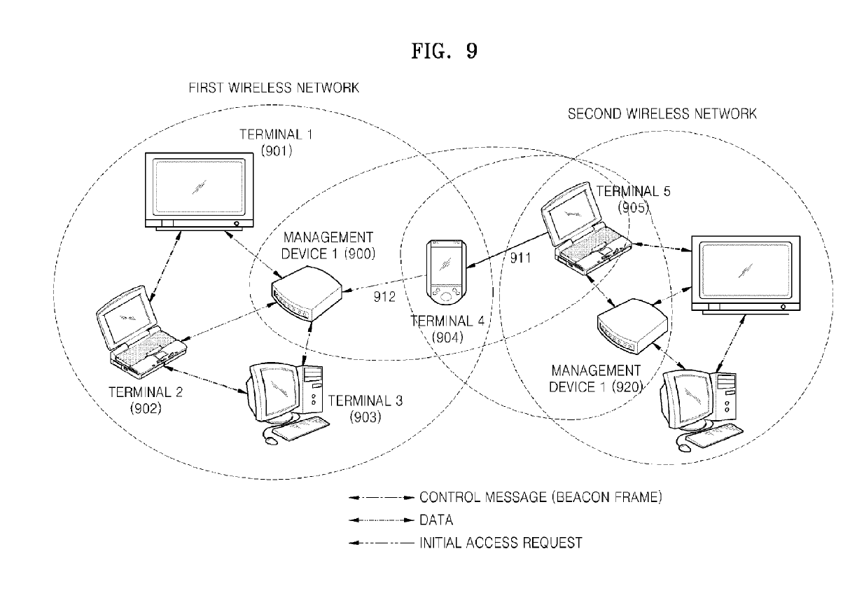

FIG. 9 is a view illustrating a state where a terminal that is adjacent to a terminal that belongs to a different network solves the initial interference problem illustrated in FIG. 1C by using the initial access request method illustrated in FIG. 7.

Referring to FIG. 9, a terminal 5 905 re-broadcasts (in the coexistence mode) beacon information.

A terminal 4 904 may generate an interference with a terminal 5 905 in an adjacent second wireless network and cannot perform transmission.

However, the terminal 4 904 receives beacon information on the adjacent network (the second network) re-broadcasted (in the coexistence mode) from the terminal 5 905 and checks a time slot used by the terminal 5 905 in the adjacent second wireless network, channel information on the adjacent second wireless network, arrangement of a QP, and the like. Thereafter, in operation 912, the terminal 4 904 can request initial access to a first wireless network to which the terminal 4 904 belongs through a CAP slot of the first wireless network that does not generate the interference with the adjacent second wireless network and so does not generate the interference. Therefore, the initial interference problem illustrated in FIG. 1C can be solved.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. In addition, a font ROM data structure according to the present invention can also be embodied as computer readable codes on a computer readable recording medium such as ROM, RAM, CD-ROMs, magnetic tapes, floppy disks, optical data storage devices, and the like.

While the present invention has been particularly shown and described with reference to exemplary embodiments thereof, it will be understood by those skilled in the art that various changes in form and details may be made therein without departing from the spirit and scope of the present invention as defined by the appended claims.

1. A beacon re-broadcasting apparatus in a wireless network in which a plurality of terminals communicate with each other through a superframe including time-divided time slots, comprising:
a beacon frame receiver receiving, from a management device managing the wireless network, a beacon frame including beacon information for communications in the wireless network and information on an echo beacon slot allocated for beacon re-broadcasting among the time slots of the superframe; and
a beacon re-broadcaster rebroadcasting the beacon information during the echo beacon slot.

2. The apparatus of claim 1, wherein the wireless network is a personal area network based on a cognitive radio technology.

3. The apparatus of claim 1, wherein the echo beacon slot includes a relay mode beacon slot for re-broadcasting to a neighboring terminal that belongs to the wireless network and a coexistence mode beacon slot for re-broadcasting to an external terminal that does not belong to the wireless network.

4. The apparatus of claim 3, wherein the beacon re-broadcaster transmits relay mode beacon information including information on a location and a length on the superframe, a modulation scheme, a coding scheme, and an allocated terminal for each of the time-divided time slots among the beacon information, to the neighboring terminal that belongs to the wireless network, during the relay mode beacon slot.

5. The apparatus of claim 3, wherein the beacon re-broadcaster transmits co-existence mode beacon information on a frequency channel used in the wireless network, and a location and a length on the superframe for each of the time-divided time slots used in the wireless network, among the beacon information, to the external terminal that does not belong to the wireless network, during the coexistence mode beacon slot.

6. The apparatus of claim 1, wherein the time slots of the superframe include one or more of a CTA (channel time allocation) slot for communications between the number of terminals, a MCTA (management channel time allocation) slot for transmission/reception of control information between the management device and the terminals, a CAP (contention access period) for initial access to the wireless network, a QP (quiet period) slot for scanning a signal of an IU (incumbent user) in the cognitive radio technology.

7. The apparatus of claim 6, wherein the CAP slot is divided from the time slots so as to be operated.

8. The apparatus of claim 1, wherein a plurality of the echo beacon slots are included in a single superframe or periodically allocated to a plurality of superframes.

9. A beacon re-broadcasting method in a wireless network in which a plurality of terminals communicate with each other through a superframe including time-divided time slots, comprising:
a beacon frame reception operation of receiving, from a management device managing the wireless network, a beacon frame including beacon information for communications in the wireless network and information on an echo beacon slot allocated for beacon re-broadcasting among the time slots of the superframe; and
a beacon re-broadcasting operation of rebroadcasting the beacon information during the echo beacon slot.

10. The method of claim 9, wherein the wireless network is a personal area network based on a cognitive radio technology.

11. The method of claim 9, wherein the echo beacon slot includes a relay mode beacon slot for re-broadcasting to a neighboring terminal that belongs to the wireless network and a coexistence mode beacon slot for re-broadcasting to an external terminal that does not belong to the wireless network.

12. The method of claim 12, wherein the beacon re-broadcasting operation includes transmitting relay mode beacon information including information on a location and a length on the superframe, a modulation scheme, a coding scheme, and an allocated terminal for each of the time-divided time slots among the beacon information, to the neighboring terminal that belongs to the wireless network, during the relay mode beacon slot.

13. The method of claim 11, wherein the beacon re-broadcasting operation includes transmitting coexistence mode beacon information on a frequency channel used in the wireless network, and a location and a length for the superframe of each of the time-divided time slots used in the wireless network, among the beacon information, to the external terminal that does not belong to the wireless network, during the coexistence mode beacon slot.

14. The method of claim 9, wherein the time slots of the superframe include one or more of a CTA slot for communications between the number of terminals, a MCTA slot for transmission/reception of control information between the management device and the terminals, a CAP for initial access to the wireless network, a QP slot for scanning a signal of an IU in the cognitive radio technology.

15. The method of claim 14, wherein the CAP slot is divided from the time slots so as to be operated.

16. The method of claim 9, wherein a plurality of the echo beacon slots are included in a single superframe or periodically allocated to a plurality of superframes.

17. An initial access request method used in a wireless network in which a plurality of terminals communicate with each other through superframes including time-divided time slots, comprising:
receiving beacon information including information on a CAP slot for initial access to the wireless network among the time slots of the superframe from a terminal in the wireless network; and
transmitting an initial access request message for requesting initial access to the wireless network during the CAP slot.

18. The method of claim 17, wherein in receiving the beacon information includes receiving the beacon information through an echo beacon slot allocated for beacon re-broadcasting among the time slots of the superframe.

19. The method of claim 17, wherein the initial access request message includes a MAC (media access control) address of a terminal that is to request the initial access and an amount of data to be transmitted.

20. An initial access request method used in a wireless network in which a plurality of terminals communicate with each other through a superframe including time-divided time slots, comprising:
receiving first beacon information including information on a CAP slot for initial access to a first wireless network among the time slots of the superframe in the first wireless network from a terminal that belongs to the first wireless network;
receiving second beacon information on a frequency channel used in a second wireless network and information on each of the time-divided time slots from one or more of a management device in the second wireless network and terminals that belong to the second wireless network; and
transmitting an initial access request message for requesting initial access to the first wireless network during the CAP slot of the first wireless network that is determined not to affect the second wireless network on the basis of the second beacon information.

21. The method of claim 20, wherein receiving the first beacon information includes receiving the first beacon information through an echo beacon slot allocated for beacon re-broadcasting among the time slots of the superframe in the first wireless network from the terminal that belongs to the first wireless network.

22. The method of claim 20, wherein receiving the second beacon information includes receiving the second beacon information through an echo beacon slot allocated for beacon re-broadcasting among the time slots of the superframe in the second wireless network from the terminal that belongs to the second wireless network.

23. The method of claim 20,
wherein the superframe in the first wireless network includes a plurality of CAP slots, and
wherein transmitting the initial access request message includes transmitting the initial access request message by selecting a CAP slot in the first wireless network that does not overlap with a time slot in the second wireless network among the number of CAP slots.
